(19) United States
(12) Patent Application Publication
(10) Pub. No.: US 2003/0233328 A1
(43) Pub. Date: Dec. 18, 2003

(54) Method and system for securely communicating data in a communications network

(76) Inventors: David A. Scott, Leucadia, CA (US); Mark D. Walsh, Carlsbad, CA (US); Richard T. Davis, Encinitas, CA (US); Patrick Tinklenberg, San Diego, CA (US)

Correspondence Address: CHRISTIE, PARKER & HALE, LLP, P.O. BOX 7068, PASADENA, CA, 91109-7068, US

(21) Appl. No.: 10/422,498

(22) Filed: Apr. 23, 2003

Related U.S. Application Data
(60) Provisional application No. 60/375,205, filed on Apr. 23, 2002.

(51) Int. Cl. G06F 17/60

(52) U.S. Cl. 705/50

(57) ABSTRACT

A computer network includes a user computer connected to a communications network, an encryption/decryption device connected to the user computer, a plurality of authentication servers connected to the communications network, an authentication server selector that determines a near authentication server for the user computer from the plurality of authentication servers, wherein the user computer is connected to the near authentication server through the communication network. In a system including a first and second computing device which each store the same series of at least one value and each store a plurality of encrypting and decrypting processes, the first computing device establishing an encrypted communications session with the second computing device using at least one of the plurality of encrypting and decrypting processes selected from the plurality of encryption and decryption processes. The encrypting and decrypting processes are selected as a function of one or more of the at least one of the plurality of values of the stored series.

### RELATED APPLICATION

This application claims priority of U.S. Provisional Application No. 60/375,205 filed Apr. 23, 2002, the entire contents of which is incorporated fully herein by reference. This application is also related to U.S. patent application Ser. No. 09/613,054, filed Jun. 28, 2000, the entire contents of which is incorporated fully herein by reference.

### BACKGROUND OF THE INVENTION

“Web servers” today are the target of hackers and those who would steal, corrupt, or deny access to personal, private, financial, and other information. “Domain name servers” today are the target of hackers who wish to spoof web sites on the web servers by changing the configuration files on the domain name servers and redirecting traffic to a false location. Technologies are continually being created, and quickly defeated by online hackers. The need for a secure data storage and retrieval system that is immune to online hackers is acute.

Even with this high amount of risk of unauthorized access to stored data, web servers and data servers are becoming a highly important means for storing and retrieving data. Prior art attempts have focused primarily on passwords, encryption, and encoded packet switching to protect data while still allowing access to it. Most passwords are easily defeated, encryption need only to have the data captured either before or after encrypting to defeat it, and the hacking of the publicly accessible devices (firewalls and computers) defeats encoded packet headers.

With the advent of increased usage of the Internet as a means of making financial and other transactions online and transmitting large amounts of data, speed and reliability of these transactions and the security of the stored and transmitted data becomes increasingly more important. Prior attempts at regulating server load and distributing data to increase accessibility have been incomplete or overly complicated, and have either sacrificed security or not taken security into consideration.

### FIELD OF THE INVENTION

The present invention relates in general to the offline data storage of information that is provided, accessed and/or retrieved over the Internet or Intranet, to the integrity and security of the data during storage, access and retrieval, to the validation of the data packets, packet data, and those interacting with such data, preventing or ameliorating denial of service attacks, preventing spoofing, and to the speed and efficiency in which the data is stored, accessed and retrieved.

In summary, an embodiment of the present invention provides a fast and efficient means for identifying system users using a user identification and data encryption device; securely storing, accessing and retrieving the data using one or more DNS, web servers, monitoring computers, transaction servers, third party transaction servers, database servers, and data servers (and in some embodiments file servers); balances the load across the network using these servers and software on one or more of these servers; provides strong resistance to “denial of service” attacks; and provides a fast and efficient method and system for maintaining the integrity and security of the data and the network.

In rapidly increasing numbers, Internet users are opting to purchase products and services online. In making these purchases, Internet users are providing Internet merchants with confidential information. In addition, there is the increasing desire by Internet users and Merchants to use the Internet as a means of storing highly confidential data. However, the use of the Internet to store confidential data has not reached its potential largely because of the lack of any means to effectively secure the access, storage and retrieval of this data. Systems currently in use to protect this confidential information fail to protect the confidential information provided by these Internet users because the confidential information is stored on online web servers in order to quickly perform transactions, stored offline and accessed through firewalls that have no way to differentiate from authorized valid public access and unauthorized valid public access as is evidenced by the success of hackers, and current systems cannot or do not prevent or detect spoofing.

Presently, Internet users' confidential information is at risk because of the constant barrage of successful attacks from Internet hackers who gain access to the web servers and misuse the confidential information stored on them causing harm to the Internet user. Hackers often use misappropriated credit card information and personal information to buy items online, sell the misappropriated credit card numbers and personal information, and use the numbers to extort payments from the merchants or credit card companies, which often pay hackers to prevent the distribution of misappropriated information.

Online merchants are also harmed by the bad publicity that results from a successful attack from an Internet hacker and loss of sales caused by the lack of confidence by Internet users in the privacy and security of the Merchant's server. Because of this reality, most Merchants will not admit to the fact that they are insecure or have been hacked and those that have, like Egghead Software, soon go out of business.

Although the electronic sales market segment is rapidly expanding, growth has been slowed by fear among customers regarding the misuse of financial information such as credit card information, debit card or checking account information that is obtained by hacking into a Merchant's online web server. Moreover, those that use debit cards or checking accounts have no Federal protections against losing their entire bank accounts as credit cards have, and for most, there is no recourse for them either. More than 86% of those surveyed are afraid of transacting online due to misuse of private information, and more than 64% of those surveyed are afraid of transacting online due to misuse of credit card, or other financial or personal information.

To allay customer concern over the security of Internet purchasing, systems have been developed to ensure the security of certain portions of the transmission process. However, these systems fail to ensure the security of the overall transaction and the secure storage of the confidential personal and financial data. Due to the need for online transactions to occur more rapidly, systems have been developed to balance the load of Internet transactions and distribute data. However, these systems fail to provide a complete or truly secure solution.

In an attempt to alleviate some of these shortcomings, there have been a number of U.S. patents addressing various aspects of the foregoing problems. Reference may be made to the following U.S. Pat. Nos. 5,093,827, 5,130,984, 5,166,926, 5,187,707, 5,197,064, 5,448,558, 550,816, 5,566,170, 5,598,410, 5,822,300, 6,014,380, 6,032,190, 6,034,957, 6,081,522, 6,085,238, 6,088,356, 6,091,725, 6,112,251, 6,192,483, 6,262,976, 6,295,299, 6,321,272, 6,327,253, 5,632,011, 6,072,942, 4,177,510, 4,621,321, 4,870,571, 5,272,754, 5,333,266, 4,805,207, 5,414,833, 5,530,758, 4,672,572, 4,259,720, 5,105,424, 5,278,955, 5,432,850, 5,353,283, 5,606,668, 5,623,601, 5,023,907, 5,448,561, 5,481,721, 5,754,774, 5,699,513, 5,706,507, 5,720,035, 5,781,550, 5,918,018, 6,061,798, 5,826,014, 4,727,243, and 6,041,355. Reference may also be made to the following U.S. patent application Ser. Nos. 0010006522, 0010016878, 0010021176, 0010034795, 0010042221, 0010044758, 0010044837, 0010044879, 0010047353, 0010049677, 0010049741, 0010052016, 0010056416.

For example, U.S. Pat. No. 6,041,355 discloses: “A method of controlling the transfer of data between a first and a second computer network comprises parsing content description language received from the first computer network by the second computer network to determine current tag information within the content description language. A completion decision is then dynamically made based upon the current tag information. In one embodiment, the completion decision may include any of the following: full data transfer between the two networks, partial data transfer between the two networks, a deferred data transfer at a later time, or a cached data transfer. Restrictions based upon a user's age, a user's access rights, cost, system resources, and time of day may also be employed to limit the transfer of data based upon the current tag information. In a preferred embodiment, the content description language is HTML. This method may be practiced by an application level proxy that is part of a firewall system protecting the second computer network from the first.”

However, this and other systems have no method to differentiate between authorized valid information and unauthorized valid information. Thus, these methods are incomplete and are routinely penetrated by hackers. Recent developments touch upon some of the aforementioned needs, but fail to realize the potential of the “near” technology discussed in the present invention, fail to prevent hackers from penetrating the system and reaching the data, fail to provide a complete or less than complicated solution to server overload, and fail to provide for the security needed to properly store, access and retrieve data. Accordingly, it would be highly desirable to have a system and method that could store confidential information provided by Internet users offline and free from Internet hacker attacks and make that confidential information available online when needed.

The Internet's domain name system was first envisioned in Domain Names—Concepts and Facilities, RFC 882, Dr. Paul Mockapetris, (1983), and Domain Names—Implementation and Specification, RFC 883, both of which are hereby fully incorporated by reference. A comprehensive discussion of the DNS and current practices and software implementations are described in detail in DNS and BIND, 4th. ed., Paul Albitz and Cricket Liu, (2001), which is hereby fully incorporated by reference.

The Internet Domain Name System is structured like a tree and is comprised of several levels of domain name servers (DNS servers). At the base of the tree is a cluster of Root Name Servers supporting the tree. At each level of the DNS tree, DNS servers respond to queries from clients, either providing the data sought or redirecting clients to other DNS servers who may have the data. Multiple DNS servers are often deployed to ensure redundancy.

The Root Name Servers each contain an identical list of available Top Level Domain Names (e.g., .com, net., etc.) and the corresponding DNS Zone Servers that resolve queries for the respective Top Level Domain Names (TLD). The TLD Zone servers each contain an identical list of second level domain names (e.g., cnn.com, uspto.gov, yahoo.com, etc.) and the corresponding DNS Servers that resolve queries for the respective second level domain names. Second level domain name servers contain an identical list of the hosts within the second level domain name (e.g., www.cnn.com, or tess.uspto.gov, detroit.ibm.us, etc.) and the corresponding IP address for the host. Optionally, second level domain name servers may contain an identical list of third level domain names within the second level domain name (e.g., detroit.ibm.us, etc.) and the corresponding DNS Servers that resolve queries for the respective third level domain names.

As discussed above, each Root Name Server has the exact same information as all of the other Root Name Servers. When a Root Name Server is queried it responds with the list of DNS Zone Server for the queried TLD. For example, a Root Name Sever queried for the address record for www.cnn.com, will respond with the list of DNS Zone Servers for .com. The client will select and query one of the DNS Zone Servers.

Similarly, the .com DNS Zone Server queried for www.cnn.com will respond with the list of DNS servers for the cnn.com second level domain name. The client will select and query one of the DNS Servers for the cnn.com second lever domain name. When selected DNS Servers for the cnn.com second lever domain name is queried for www.cnn.com it will respond with the IP address(es) for the server hosting the web site. Lastly, the client will select one of the IP address(es) supplied and establish the connection.

Because of size limits imposed on each DNS Zone file (e.g., the DNS Zone file for .com) each second level domain is typically allowed up to six Domain Name Servers listed in the TLD Zone file). Further, many implementations of DNS server software desire at least two Domain Name Servers be listed for each second level domain name). The prevailing view is that if one Domain Name Server is busy or otherwise unreachable, the other Domain Name Server(s) will respond. If all the Domain Name Servers are busy, then the user will be unable to contact the domain. In the case where two or more servers are provided in response to a query, one server is selected either by a random process or by round-robin.

Many DNS queries are not performed directly by clients. Instead, clients are typically configured to query one or more DNS servers which perform the queries and resolve address on behalf of the client. Once the DNS server has obtained the requested data, it responds to the client. Internet Server Providers (ISPs) typically operate one or more DNS servers that provide DNS resolution for clients. Further, many of the DNS servers are programmed to cached the answers received, thereby significantly reducing the load on the Root Name Servers and Zone Servers, as well as reduces network traffic for the ISP. These DNS servers are optimized to determine which Root Name Servers and Zone Servers respond faster, and then submit their queries according. That is, DNS queries are performed without regard to where the client is located or where the web server (for example) is physically located.

### SUMMARY OF THE INVENTION

The present invention is directed to securely control access to things such as, buildings, computers and information, to secure individual computers, local and wide area networks, to provide quick and efficient storage, access and retrieval of data while maintaining system integrity, to securely store, access and retrieve data on wide and local area networks, and to secure communications between parties that involve the use of the internet, wireless, local area networks, and wide area networks.

This is achieved by optimizing network system integrity, data security, accessibility and speed; providing high resistance to server overload; protecting domain name servers and monitoring root domain name servers; distributing the data over wide and local area networks utilizing a “near data” technology to optimize data access, storage and retrieval; optimizing the intelligent and secure storage, access and retrieval of data; protecting data being accessed, stored or retrieved from servers on a local or wide area network; controlling access and preventing unauthorized physical, online, and offline access; encrypting and decrypting data, using “three dimensional” encryption, and compressing the encrypted data that is stored on the servers; encrypting files and streaming data; and securing Internet communications and Ethernet adapted communications and protecting data stored on one or more individual computers that are part of a wide or local area network.

### BRIEF DESCRIPTION OF THE DRAWINGS

The above and other objects and advantages of the invention will be apparent upon consideration of the following detailed description, taken in conjunction with the accompanying drawings.

FIG. 1 is a diagram of a system according to an embodiment of the invention.

FIG. 2 is a diagram of the system according to an embodiment of the invention.

FIG. 3 is a block diagram of the system according to an embodiment of the invention.

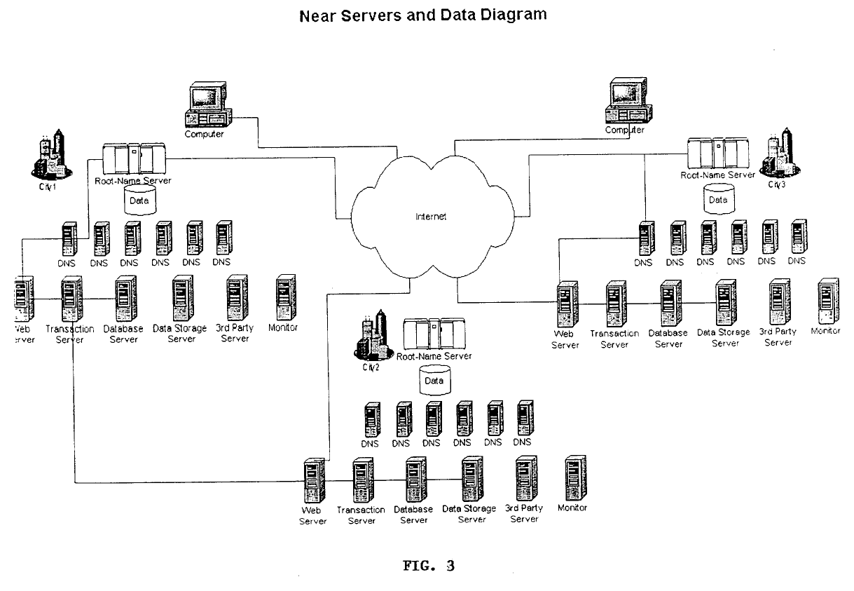

FIG. 4 is a diagram of the schematics of a personal identification device and a encryption/decryption device according to an embodiment of the invention.

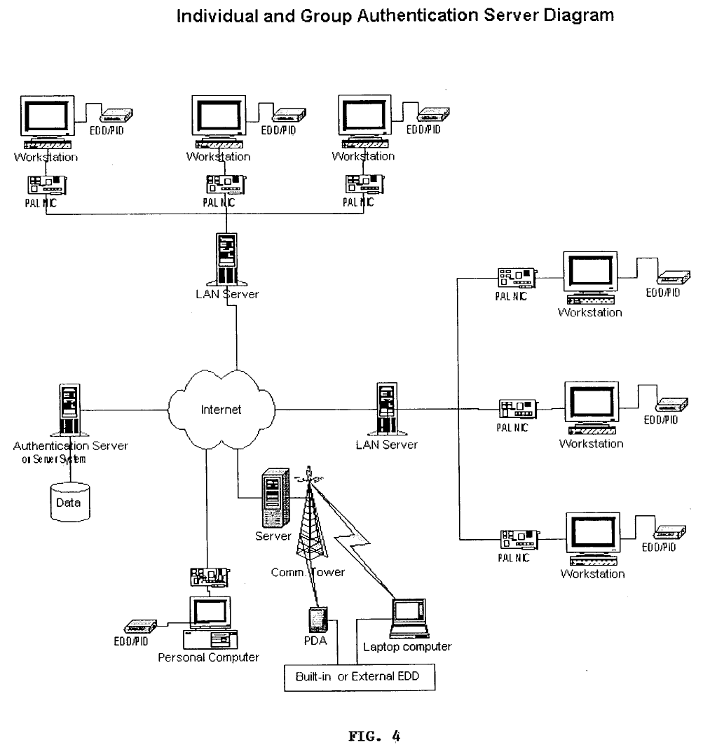

FIG. 5 is a diagram of the “private authentication layer” technology according to an embodiment of the invention.

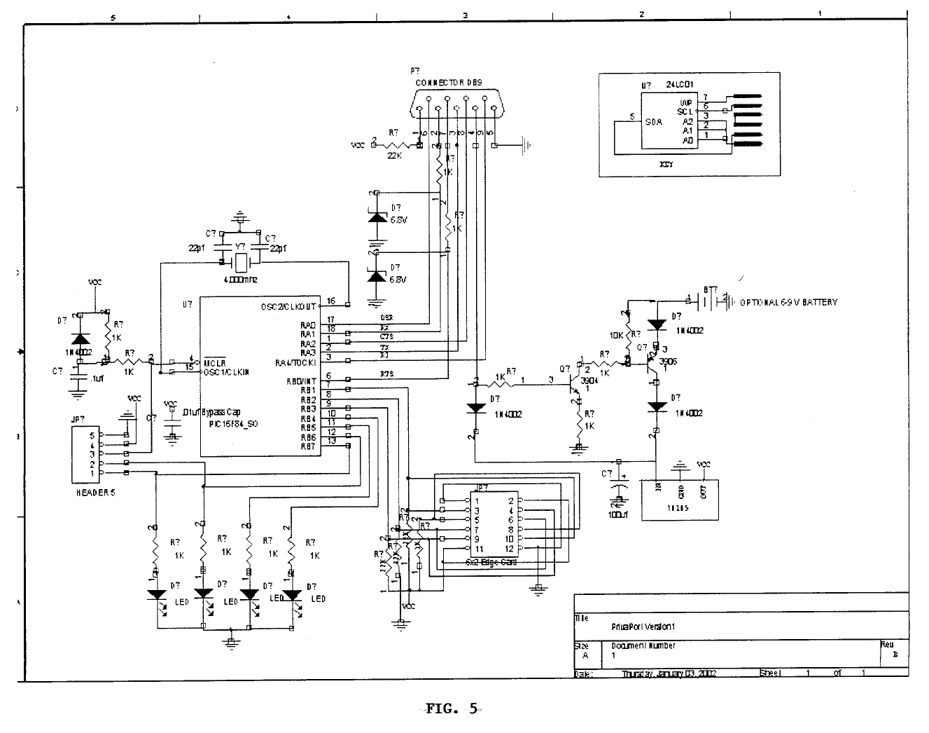

### DETAILED DESCRIPTION

A system according to an embodiment of the present invention uses one or more multitasking servers that are preferably located in a secure installation that have all forms of online administrative access disabled and alternatively the operating system would be modified to nonstandard specifications to prevent ordinary direct access (as described below). The system may be connected to the Internet and may or may not also possess a firewall to help filter or block denial of service (dos) attacks. For additional security, each operating system command file (not shown) on the present invention is renamed and placed in a different directory than normal (For example: /bin/cp might become /xyz/xyz/101.).

Unlike existing DNS technology, in one embodiment of the present invention, the Root Name Servers no longer contain the exact same information as each other. Instead, each domain name record on one Root Name Server has a different IP address for the Domain Name Servers associated with that domain name than the same domain name record on a different Root Name Server. Each domain name record will possess two or more different local Domain Name Server IP addresses local to the Root Name Server that is different from the two or more different Domain Name Server IP addresses located on the other Root Name Servers.

The local Domain Name Servers possess software to modify zone files directing incoming traffic to a local web server with available capacity for load. That local web server will forward the communication to a local transaction server with available capacity for load that will in turn contact a local database server with available capacity for load to determine the location of the data server group that stores the client's information (initially stored local to the client's ISP, and most likely local to the current database of the present transaction—unless the client is traveling or has moved). Now that the appropriate group of data servers storing the client's information has been found, the communication is then routed to all take place on a group of web servers that 1) preferably possesses the replicated web pages of the domain the client wishes to contact or transact with and 2) are local to the data server storing the client's information. Where the web pages of the domain the client desires to contact or transact with is not replicated across the system, the communications now take place by and among the client's IP address, the IP address of a web server local to the client's data, and the IP address of the domain.

One important benefit of near technology is allowing for companies to create web pages designed specifically for the customer (e.g. currency, language). Web sites replicated in France can be replicated in that language with French currency. Web sites not replicated can instead be designed differently for each language or currency and be stored under a specific IP address where the zone file on a transaction server local to the client's information directs the communications based upon the language and/or currency of the client.

An example is a client that desires to communicate from Paris, France to a domain that is replicated throughout the system is first directed to a Root Name Server local to France, from there to an available Domain Name Server local to Paris, France, and from there to an available web server local both to Paris, France and an available local data server that possesses the client's data. The communication then takes place between the client's IP address, and available web servers local to the client's data. This results in faster communications because it takes place locally to the client and because it is combined with the load balancing system described herein.

An added benefit to the technology is that where web sites aren't replicated across our system, the financial transaction can still be performed faster because the part of the financial transaction that involves the customer can or will take place local to the customer and that part of the transaction that involves the merchant or other party can or will take place local to that merchant or other party.

Another benefit is that under the current system, a root name server in France will direct traffic to a domain name server in San Diego for a website hosted in San Diego, and a root name server located in the US will also direct traffic to the same domain name server. The modified system would direct traffic originating in France to a domain name server in France and a root name server in the US would direct traffic to a domain name server in the US, thus increasing the simultaneous traffic handling capabilities two-fold. Doing this across all of the 13 current root name servers, yields up to a 13:1 increase in simultaneous load capacity. The additional benefit of lower latency moves traffic through the system faster, thus opening bandwidth to additional traffic load.

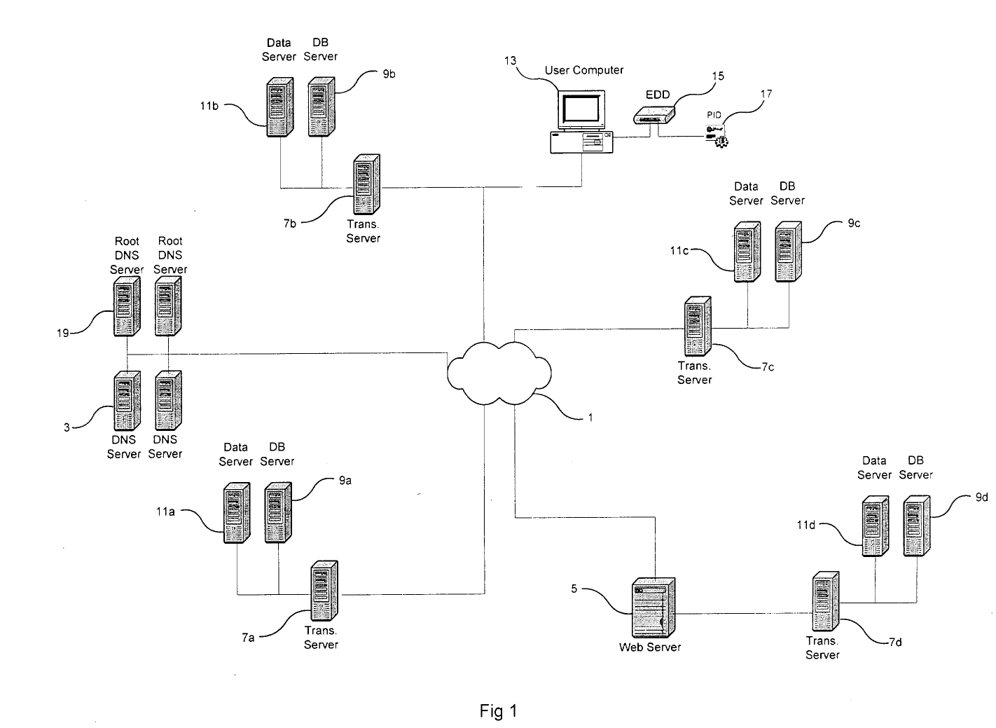

Turning to FIG. 1, connected to the Internet 1 are preferably two or more Domain Name Servers 3 and two or more Root Domain Name Servers 19. If only one Domain Name Servers 3 is connected, then there may be one or more Domain Name Servers 3 in reserve. Similarly, if only one Root Domain Name Server 19 is connected, then there may be one or more Root Domain Name Servers 19 in reserve.

Also connected to the Internet 1, is one or more Web Servers 5. If only one Web Server 5 is connected, then there may be one or more Web Servers 5 in reserve. The Web Server 5 is programmed to provide the means and direction for the use of the data being stored, accessed and/or retrieved (an “operation”). All servers in the system may also have telnet, ftp, and all other public administrative access methods disabled to deny public administrative access, and all have their commands renamed and moved so that no two are alike.

In communication with the Web Server 5 is one or more Transaction Servers 7a-7c. Additionally, the Web Server 5 may also be privately connected to a Transaction Server 7d. The Transaction Server 7 (reference to the Transaction Server 7 is a generic reference to any one or more of Transaction Servers 7a-d shown in the Figures and may include additional one or more Transaction Servers (not shown) instead of or in addition to Transaction Servers 7a-d) communicates directly with one or more privately connected Database Servers 9 (reference to the Database Server 9 is a generic reference to any one or more of Database Servers 9a-d shown in the Figures and may include additional one or more Database Servers (not shown) instead of or in addition to Database Servers 9a-d), one or more privately connected Data Servers 11 (reference to the Data Server 11 is a generic reference to any one or more of Data Servers 11a-d shown in the Figures and may include additional one or more Data Servers (not shown) instead of or in addition to Data Servers 11a-d), and other function and non-function specific servers as needed. These communications may be via a public or privately communications network. Additionally, these servers'functions may be consolidated into one or more servers. For example, the functions of the Data Server 11 and Database Server 9, may be consolidated into the Transaction Server 7.

One or more monitoring computers determine which servers are active, available, and best able to process an operation at any given moment. In one embodiment, the monitoring computers may be privately connected to the servers. For instance, a monitoring computer can determine which data Transaction Server 7 and which Web Server 5 are the best available server (for example, least amount of load) to handle a data packet during an operation. The monitoring computers, as further explained below, may also track load and availability of the servers in the system, other monitoring computers and any other function/non-function specific server(s) that might be put into service.

User Sends Data to Web Server

During a desired operation, a Client/User Computer 13 requests the address of a Web Server 5 from a Domain Name Server 3 and/or Root Domain Name Sever 19. The Domain Name Server 3 provides the Client 13 the address of one or more Web Server 5. The Client 13 then contacts the Web Server 5 to request a transaction. The Client 13 can be any type of computing device such as a personal digital assistant (P.D.A.) or other hand-held computer, a point of sale system, or other computing device.

The Web Server 5 receives the requested transaction from the Client 13. The Web Sever 5 generates a packet of data that is passed the Transaction Server 7 with a request type prepended to the packet to identify the requested transaction (an operation to be performed by the system). The Transaction Server 7 is responsible for querying the Database Server 9 and/or other servers as designated by the packet header to initiate or complete the operation, or to request the location of Database Server 9 that contains the user's data so that it can be accessed.

The Transaction Server 7 is programmed to open and validate the incoming and outgoing data packets received from the various servers. If the data packet does not validate, it is presumed that the packet is not authentic, the data is discarded and the user notified or another appropriate action is taken. If the data packet is validated, a Client identifier on the packet headers is compared to a Client identifier database on the Database Server 9.

Once the Client identifier is validated, The Transaction Server 7 determines whether or not the user's data is stored on the Data Server 11 local (in the same facility) to the Database Server 9 or other function specific server that validated the Client identifier, the operation continues on the system at the present location. If the Client identifier is associated with data located on a Data Server 11 at a different location, the present data Transaction Server 7 will route the Client's operation request, preferably in encrypted form and optionally compressed, to a Web Server 5 that is local to the Transaction Server 7d through a private connection at the location where the user's data resides to complete the operation. In the latter situation where the data is located at a different location, the rest of the operation, if any, will occur via the Web Servers 5 and Transaction Server 7 where the user's data is located.

The Database Server 9 or other servers that are local to the “near” (defined below) Data Server 11 storing the user's data maintain the persistent state of the requests and act as a “cookieless” persistent state session log, the log time or value depending upon the various operation. Using the Client identifier as the persistent state device, login times and function-specific timeout values are written to the Database Server 9 or other appropriate server (such as an access server). The Transaction Server 7 checks the Database Server 9 before returning any data packets to the Web Servers 5 for Client 13 display. If a timeout or other disqualifying event has occurred, the returning packet is modified to reflect the current status of the request and a new authentication takes place or other appropriate action taken. A new authentication can take place at any point during the operation.

The user's data is preferably stored on a Data Server 11 that is located “near” the user's ISP access point (not shown). Users desiring to store, access or retrieve their data, begin by contacting a specific host name using the present system. The Client 13 may be directed to any one of a number of physical servers using the system by the Internet's domain name system as described above. Once connected to any server using the system, that server will determine which server is located “near” the user's ISP access point. In an embodiment, a “near” server is one where the route in which the traffic will take to its destination will equal the most currently available, optimal (e.g., minimal load, fewest number of hops or other optimization criteria). This is accomplished by assigning each Client 13 a unique identification number, and by maintaining a distributed list of the Client 13 numbers and the respective “near” servers on each server using the invention. Once a Client 13 is directed to a server using the system, that server can look up the “near” server and redirect the Client 13 accordingly. User's data may move to a new Data Server 11 “near” the user's new ISP access point if the user changes their ISP access point.

Unless the user's ISP access point changes as described above, once assigned to a particular Data Server 11 group, all subsequent data relating to that user's Client 13 will be accessed on that particular server or servers. An account number (Client identifier), assigned to each Client 13, along with the Data Server 11 group identification is propagated to all the Database Server 9 on the network so that any incoming request for that Client 13 will be routed to the one or more “near” Data Servers 11 where the data resides. This allows for transactions to occur closer to the Client 13 and potentially at an optimized faster speed.

Additionally, by identifying the location of the Data Server 11 “near” the Client's location, interaction with the user using Client 13 can be localized for the user. One example of localization is communicating with the user in the local language or dialect. Another example is using the correct currency and financial units. Of course, user preferences could override system made assumptions.

Now that the Client 13 has been identified and the operation is being performed at a location “near” to the Client 13, the user is authenticated. Authenticating the user has the obvious purpose of protecting the data from unauthorized access. The Transaction Server 7 once again compare information in the data packet with information on the Database Server 9 or other server used for authentication to authenticate the user. This can be done with a simple user id and password submitted by the user via the Web Server 5 scripts that is received with the data packet and compared with data on the Database Server 9 and/or Data Server 11. This method of authenticating the user under the system can stand on its own, but in alternate embodiments the user will be authenticated using an authentication system as disclosed in U.S. patent application Ser. No. 09/613,054, owned by the assignee of the present application, which is incorporated by reference fully herein. This authentication system involves the use of any personal identification device (PID) 17 such as a magnetic stripe card, a smart card or any other personal identification device, a random question/answer password, and an encryption/decryption device (EDD) 15. The authentication system as discussed in an embodiment of the invention includes a unique PID 17, a unique EDD 15, a series of encryption systems, and one or more “near” Database Server 9 and/or one or more “near” Data Servers 11. For additional authentication, a biological identifier can be used such as an iris scan, a fingerprint, D.N.A., a bone scan or hand scan.

Under an embodiment of the invention, the PID 17 is a printed circuit board with 6 fingers on each side that are configured to fit into an industry standard 100 center dual row edge card connector. Reading left to right they are numbered 1-6. Reading left to right from the other side, they are numbered 7-12. In the preferred embodiment, finger 1 is connected to the ground on a non-volatile memory device, a microcontroller, or other device capable of storing data to and reading from it that does not require electricity to maintain the data, finger 2 connects to the data line on the non-volatile memory chip, microcontroller or other device. Finger 3 is for an incoming signal. Finger 4 connects to finger 3 to provide for signal sensing for insertion and removal sensing. Finger 5 connects to the clock line on the non-volatile memory chip, microcontroller or other device. Finger 6 connects to the power line of the non-volatile memory, microcontroller or other device. Fingers 7-12 perform the same functions as the corresponding fingers on the other side 1=7 2=8 3=9 4=10 5=11 6=12. This allows the fingers on the PID 17 to be inserted either way and provides redundancy to allow it to function if any one of the fingers are damaged and the other is not. Other combinations are possible.

The non-volatile memory on the PID 17 is used to store: a) the serial number of the PID 17 and/or some other identifier, b) an encrypted form of the most recent transaction code (or encryption key), c) a version number, d) flags such as “active” or “disabled”, and e) any other information as needed or that the user desires (limited of course to the size of the memory chip).

The EDD 15 is a microcontroller run device that reads and writes to the nonvolatile memory on the PID 17, has LEDs to signal events to the user and a means of external access such as RS232 or USB (preferably RS232 for security purposes). The EDD 15 has internal non-volatile memory where certain information is stored, including but not limited to a serial number and/or some other identifier, a transaction code, a version number, and the means for encrypting and decrypting, and optionally compressing data (as described below). The EDD 15 can also possess other functional items such as a keypad, a display, a printer, more than one slot for the PID 17 to be inserted, a battery, other functional items, and store additional information as needed.

Optionally, the EDD may contain a Global Positioning System (GPS) receiver. The GPS receiver may be used to communicate the exact location of the EDD to the server during authentication. The system may authenticate a user as function of the location of the EDD. Additionally, the GPS receiver may receive accurate time, which may be used as a key value during encryption.

The encryption system, in an embodiment, involves at least one serial number from the personal identification device, one serial number from the encryption/decryption device, or one other unique identifier either from the PID 17, the EDD 15 or one of the servers, at least one variable key (transaction codes) either from the personal identification device, from the encryption/decryption device, or from one of the servers, and at least one version number from the personal identification device, from the encryption/decryption device, and/or from one of the servers (the variable keys, identifiers and version numbers can originate from any of several sources that are components of the present invention). The identifier is at least eight or more Bytes in length. The encryption key does not have to be at least as long as the identifier. Under this encryption system, the very first step is to implement an encryption process such as an exclusive OR (EXOR or XOR) of the encryption key with the data to be encrypted. Using standard encryption methods, 0+1=1, 1+0=1, 1+1=0, 0+0=0. The next step is to evaluate the bits of the serial number or identifier. For example, if bit 0 of the first Byte is a 1, then we perform the first of the encryption schemes, such as DES, AES, blowfish, square, etc. If not, then we don't perform that encryption. If Bit1=1, then we perform the second of our encryption schemes in a different sequence, such as blowfish, AES, and DES. If not, we don't perform any. And this is repeated for Bits 2-7. If we repeat this, for any number of bytes, using different encryption routines and/or a different sequence of routines, this yields a unique encryption system for any given serial number or identifier. In order to encrypt, the serial number and/or identifier determines the sequence of encryption routines, and the encryption key determines the outcome of each of those routines, and the version number determines which of those encryption routines are used (the version number can be changed or disabled at any time). There is a desired minimum of eight routines that are used because the security level of the encryption is reduced by having less than eight routines (the absolute minimum however is 2 routines). The maximum number of routines is equal to the number of bits to be encrypted.

Every time the data is accessed on the EDD 15 or the PID 17, the EDD 15 hops (non-sequentially changes) the transaction code, using a version specific and/or EDD 15 serial number specific algorithm programmed into the EDD 15 and known to the server software. Because of the automatic hopping of the transaction codes, the encryption sequences are asymmetrical. Encrypted data may be transmitted under a key that is not currently known to the server. The server must also perform the hop to get the key in order to be able to decrypt the data.

The EDD 15 can be used as a key generator to encrypt files. Software on the server communicates with software on the Client 13 to log a transaction code hop and assign the new encryption key and/or compression to a particular file. The software on the server sends a packet to the EDD 15 with a “begin session” command embedded in it. The software on the Client 13 then sends a packet to the EDD 15 to generate the new encryption key. When the key is received, the data file is encrypted using that key and the software on the server is notified of the file name and completion of the process. The server logs the filename, and the encryption key then sends an “end session” to the EDD 15.

When that file previously encrypted under that key is desired to be decrypted, the software on the Client 13 notifies the software on the server of the filename to be decrypted and/or uncompressed. The software on the server looks up the file name and the key used to encrypt it then begins a session on the EDD 15. Next, the server sends a new transaction code (a hop prior to the one generated for encryption) to the EDD 15 and notifies the Client software to query the EDD 15 for the key. Once the Client software receives the key, it decrypts the file using that key. The Client software notifies the server of the completion and the server sends a new transaction code to the EDD 15 along with an “end session” instruction.

Using this system, a file can be encrypted on one computer using an EDD 15 and decrypted on a different computer and a different EDD 15.

Another option is to send the EDD 15 a “begin session” along with a new transaction code to two or more EDD's 15 then to instruct the software on one computer to query its EDD 15, encrypt blocks of data, then send them block-wise to the recipient where the data is received and unencrypted using keys generated on the local EDD 15 continuing until the data stream has been exhausted or the session has ended. In the preferred embodiment, the software on the system servers must be notified that each block of data has been received so it can seed the EDD 15 to provide the proper decryption key. This is necessary if the EDD 15 has no internal method of encrypting or decrypting anything other than its own data. This is because of the 3^{rd} dimension utilized in the encryption scheme that guarantees that no two EDD's 15 use the same encryption system to encrypt data. Given this circumstance, only the server would be able to properly seed an EDD 15 and that being accomplished, would not allow for a one-time use. The server accomplishes this by taking the encryption key from one EDD 15, hopping it under a different EDD's 15 system, then “back-hopping” a step using the destination EDD's 15 system. The destination EDD 15 having been seeded, hops then sends the proper decryption key to the Client software.

In one embodiment, the transaction codes (encryption keys) are variable or random and a different identifier will be associated with each user. As such, it is highly unlikely that an individual encryption system will encrypt the data the same way twice and that no two identifiers will result in having the same encryption system. Every time an encryption key is used, the encryption key will preferably change in a non-sequential fashion.

This encryption system can be used as a stand-alone encryption system or as a key generator for any other encryption system such as AES or DES. Where the encryption system above does not generate a key with a sufficient number of bits to meet the requirements of another encryption algorithm, the key can be replicated to meet the number of bits required, or enlarged using other predefined variables. Where the encryption system above generates a key with more than a sufficient number of bits needed to meet the requirements of another encryption algorithm, then only the number of bits of the key that are needed are used, which bits are used being based upon a number of predefined variables.

This encryption system can also be used for encrypting files and streaming data by using the EDD 15 as a key generator to encrypt files and/or data packet that includes using software on the Client 13 to use the EDD 15 to generate a new key to encrypt the file and/or data packet on the Client 13, the EDD 15 communicating with server software to send the server software notice of the new key, not the key itself, and the encrypted file and/or data packet, the server software receiving the notice and tracking the keys generated by the EDD 15, the server software communicating with the recipient's EDD 15 and seeding the recipient's EDD 15 with a key that will on its next hop match the key generated by the first EDD 15 (this is needed where 3 dimensional encryption schemes are used because the 3 dimensional encryption scheme guarantee that no two EDD's 15 use the same encryption system to encrypt data), and using software on the recipient's computer that utilizes the key generated by the recipient's EDD 15 to decrypt the file and/or data packet.

In order for authentication of the user to occur, the user or a third party requests the authentication. One or more Web Servers 5 are directed to contact the EDD 15, validate it, and then request the EDD 15 to send the PID 17 information. The EDD 15 is contacted, and powered up by asserting DTR on one of the RS232 communication ports on the Client 13 or other RS232 device. The EDD 15 can be line powered by the RS232 port or by an onboard optional battery. When the DTR line is high, the EDD 15 is powered up. The CD line goes high immediately upon power up. The CTS line is driven high by the EDD 15 after it has successfully passed its startup stabilization period. The Web Server 5 then asserts RTS after determining that the EDD 15 is ready by watching for the CTS to go high. The EDD 15 acknowledges by dropping CTS. The Web Server 5 then sends a packet to the EDD 15. The EDD 15 evaluates the packet and then responds with a response to the request that was embedded in the packet. The EDD 15 also turns on a LED to notify the user that communication with the Web Server 5 has been established. If the packet is not in the proper format, does not contain the correct number of bytes for the current encryption version written to the EDD 15 or a valid request is not embedded in the packet, the EDD 15 flashes a LED (the validation led) telling the user that proper communications did not occur and to assume he/she is connected to an imposter system.

Assuming that a valid contact has been made, if the user is wanting to make a transaction with a third party such as a merchant, or to gain access to something that requires authentication such as a building, software, a network, etc. software on the system servers (combination of software on the Transaction Server 7 that processes the encryptions systems and compares validation and authentication information received from the Web Servers 5 with that on the Database Server 9 and software on the Web Server 5 that communicates with the EDD 15 and the Transaction Server 7) validates the third party by sending a request for validation to one or more Transaction Server 7 where the third party's IP address and DNS information is compared to that information stored on a Data Server 11 “near” to the third party. After validating the user and validating the third party's IP address (or other identifier such as an EDD 15) and DNS information, then we communicate that validation is communicated to both the user and the third party. Optionally, this communication can occur by secure socket layer utilizing a fourth party to validate a digital certificate on the server system of the present invention.

If the third party were a web, public or private information server, the server system could be used to proxy HTTP packets between the Client 13 and third party. HTTP packets from the Client 13 would go to a Transaction Server 7, that would validate the header packet, and relay it to the third party. Likewise, HTTP packets from the third party would be sent to the same or different Transaction Server 7, be validated, and relayed to the first party. This validates the user access to the public information servers, to help protect them from unauthorized access.

The results of the validation request are sent by the Transaction Server(s) 7 to one or more Web Servers 5 to continue the session. The session is also logged in a session database on the Database Server 9 along with a timeout value. Each subsequent communication with an EDD 15 must occur within that time limit or the validation process begins anew. When the third party has been validated, the EDD 15 is notified, which then lights another (third party) LED telling the user that the third party has been validated. The EDD 15 will flash the third party LED if the validation did not occur. One or more LEDs on the EDD 15 may provide various signals to indicate various intended communications to the user.

Next, the EDD 15 is requested to send its serial number (and/or identifier) and internal transaction code to the server. Before sending its internal transaction code, the EDD 15 hops it under a new encryption key using a non-sequential, asynchronous system (a hop).

Server software compares the serial number (and/or identifier) with EDD 15 serial numbers (and/or identifiers) on the EDD 15 database. Server software then compares the EDD's 15 last transaction code, encrypts it under the new scheme and compares it to the data received from the EDD 15. If the new transaction code does not validate, the server software attempts additional encryption hops looking for a match. If a hopped transaction code match is found, the software compares the current IP address of the Client 13 (obtained when the user originally requested access validation) to those that were logged on previous connections. If the current IP address is not logically the same as those used on previous transactions, the EDD 15 is sent a command to disable itself and the EDD 15 database is flagged as this EDD 15 being invalid. If the current IP address does match or logically matches previous IP addresses, the EDD 15 is sent a new transaction code and requested to return the hopped value. The EDD 15 database is flagged as this EDD 15 possibly being defective. The new hopped transaction code is compared to the new hopped version on the server software and if it does not compare to the one sent by the EDD 15, the EDD 15 is sent a “disable” packet and the EDD 15 is flagged as disabled in the EDD 15 database on the Database Server 9 or authentication server (not shown).

After the EDD 15 transaction code has been validated, the EDD 15 is instructed to encrypt and send the PID 17 data, using the new transaction code after first performing another transaction code hop. Server software knows the PID 17 has been inserted into the EDD 15 because the EDD 15 sends DSR high when it is in. The EDD 15 also sends a flag notifying the software if the PID 17 has been removed before the session has been completed. If that occurs, a re-validation of the EDD 15, user and PID 17 is made before proceeding. A re-validation of the EDD 15 and PID 17 can occur at any point during the operation.

The PID 17 information is unencrypted by the server software using the current scheme of the EDD 15. The PID 17 information includes the encryption version number of the last EDD 15 to encrypt data on the PID 17, the PID 17 serial number (and/or identifier), and an encrypted transaction code. Other encrypted data can optionally be stored on the PID 17, such as wallet amounts to be used in vending machines, telephones, etc and or other data as desired.

The server software validates the PID 17 serial number and/or identifier and then decrypts the PID 17 transaction code using the encryption version designated by the version number stored on the PID 17. If that code does not match, the same hop/compare algorithm used on the EDD 15 is applied to the PID's 17 transaction code. If a match is not found, the EDD 15 is instructed to run an integrity check on the PID 17 by reading and writing to all the memory locations on the PID 17 to verify each byte, disable or erase the PID 17 as appropriate.

If the PID 17 transaction code does validate, the server logs the event, generates a new transaction code for the PID 17 and sends it to the EDD 15 where the EDD 15 hops it then writes the new values along with its encryption version to the PID 17.

Upon validation of the PID 17 and EDD 15 serial numbers and/or identifiers and transaction codes, one or more random passwords are generated from information previously provided in the user's file on the Data Server(s) 11 by the Transaction Server(s) 7 and routed to one or more Web Servers 5 where it is presented to the user for a response using scripts on the Web Server(s) 5. The user's response is then routed to one or more Transaction Server 7 via the Web Servers 5 where it is compared against the correct answer provided from the user's file. If the user's response is correct, the operation proceeds. If the user's response is incorrect, the user is asked additional random questions/answers in the same manner until the user gets a random password question correct, or the operation is cancelled upon failing to answer a predefined number of random questions.

Now that the operation is taking place on a system “near” to the Data Servers 11 that possess the user's data, and now that the data packet and user have been authenticated, the operation proceeds. Where the operation involves storing user's data on one or more Data Servers 11, the data received by the Transaction Server 7 is preferably received both in separate pieces due to the scripts on the Web Server 5 and encrypted via hardware (such as an EDD 15) or software on the user's computer and/or also compressed prior to being submitted to through the Web Server 5. Otherwise, the data is received as a whole and is split by one or more Transaction Server 7 and/or the data is received unencrypted and is encrypted by one or more Transaction Server 7 and/or received uncompressed and compressed prior to being placed on one or more Data Servers 11 (i.e. multiplexed: divided and written to more than one Data Server 11). In addition or as an alternative, the data can be stored on one or more hard drives (not shown) on a single or multiple Data Servers 11. Each piece of data or entire piece of data is also preferably written two or more times to different recordable media, or different servers, in the same or different physical locations to provided for data redundancy.

Where the operation involves accessing or retrieving data from a Data Server 11, the data packet is opened by the Transaction Server 7 and the operation request is processed by collecting the requested data from the one or more Data Servers 11 on which the data is stored, unencrypting and decrypting (as needed) the data and assembling any pieces of data in temporary volatile memory (not shown) on one or more Transaction Servers 7. If the user possesses decrypting and optionally decompression software or hardware, the Transaction Server(s) 7 encrypts the assembled data, and compresses the data if applicable, and routes the encrypted data packet to the requesting computer, such as a Client 13 or decrypting hardware via one or more Web Servers 5 that may or may not be the same Web Server 5 that began the operation. The encryption systems used to encrypt data by and between the Transaction Server 7 and the Data Server 11 is preferably the same as those used for authenticating the PID 17 and/or EDD 15. If the Client 13 possesses decrypting software or hardware that is also capable of assembling data, the Transaction Server(s) 7 can simply encrypt the unassembled data and route each encrypted data packet to the Client 13 or decrypting hardware via one or more Web Servers 5. Otherwise, the Transaction Servers 7 simply forward the requested data assembled as a whole. Prior to returning the requested data back to the Client 13, in some embodiments the user is once again authenticated and software is possessed on the Client 13 that monitors whether their computer is being hacked or possesses listening software placed on the computer by a hacker.

Where the operation involves using user's data in a transaction with a third party such as a company or financial institution, any of the Transaction Servers 7 may be one or more offline or privately connected Third Party Transaction Servers. The Third Party Transaction Servers, like the Web Servers 5, have telnet, ftp, ssh, rlogin, and all other public administrative access methods disabled to deny public administrative access. The Third Party Transaction Server then routes the assembled data, preferably in encrypted form, to a third party server(s) (not shown) for processing. The result of the transaction with the third party is then returned to one or more Third Party Transaction Servers where the resulting data is stored in temporary volatile memory and routed to one or more Data Servers 11 where the user's file is decrypted, optionally decompressed, opened and updated and then re-encrypted, optionally recompressed, and stored. Simultaneously, the outcome of the transaction (operation results) is routed to one or more Transaction Server 7 where it is stored in temporary volatile memory, routed to the Web Servers 5, and then forwarded to the Client 13 in the same manner as during a standard operation involving accessing and retrieving data.

The system also operates with transactions between two or more users. Although FIG. 1 shows only one Client, generally, in the case of multiple users, each would use their own Client 13 (not shown). The operation begins when an operation request is made by a first user to transact with a second user on one or more Web Servers 5. As with previous operations, the data packet and first user are validated and authenticated and the operation is routed to the location where the first user data file is stored (if not already at that location). The operation request is then stored in the first user's file in the same manner as other operations where data is stored in the user's file. Simultaneously, one or more Transaction Server(s) 7 perform a minimum of three additional tasks. First, one or more Transaction Servers 7 contact the local Database Server 9 to locate the one or more Data Servers 11 that store the data files for the second user and that may or may not be located at another secure location. Second, the Transaction Server 7 preferably encrypts, optionally compresses, then routes a copy of the operation requests to the one or more Data Servers 11 that store data file for the second user where it is added to its files in the same manner as previously stated. Third, the data file for the second user is accessed and an email or other form of communication is made to the second user notifying them that the first user wishes to transact. These tasks can be performed by the Transaction Server 7 via an email server (not shown). The next step occurs when the second user receives the communication and accesses the system to retrieve the operation request. This is done in the same manner as a normal data retrieval operation described above. The operation request contains a manner in which the second user can respond. If the second user responds in the negative, the first user is notified and the first user's data file is updated in the same manner that the second user was notified of the operation request. The second user's data file is also updated. If the second user responds in the affirmative, then the operation request is completed. If the operation involves a Third Party Server, the operation is completed as other third party operations, each user being notified of their appropriate results. If the operation involves an exchange of data, only that data that is authorized is delivered, and the data is delivered in the same manner as accessing or retrieving data operations, only this time, each user connects with the “near” Web Servers 5, “near” Transaction Server 7, “near” Database Server 9, and “near” Data Servers 11 where the other user's data is stored and the data is then retrieved. Upon concluding the operation, both user files are updated.

An embodiment also includes one or more offline or privately connected monitoring computers (not shown) that are multi-tasking. These monitoring computers possess software (not shown) that maintain constant communication with the system servers 5-11 and the other monitoring computers. The purpose of the communication is to monitor and control the status of the servers, monitor administrative access to the servers, monitor and control the load thresholds of each of the servers 5-11.

In order for the present invention to balance the load, the system servers 5-11 all possess software (not shown) that write load status files to a specific directory either on the server 5-11 or on one or more monitoring computers, or to otherwise communicate the current workload status to the monitoring servers. The offline monitoring computers monitor these specific directories for traffic load files. The monitor servers do not rely exclusively on communication from the various servers themselves, but they also monitor port activity and based upon software on the monitor server(s) make load decisions from that activity or inactivity as the situation demands.

When one of the Web Servers 5 or DNS Servers 3 have reached a predetermined load threshold, the offline monitoring computer changes the existing DNS Server 3 configuration files to cause traffic to be redirected to other Web Servers 5 or it can take that DNS Server 3 offline, automatically shifting traffic to the next registered DNS Server 3 which is configured to direct traffic to other Web Servers 5. When one of the other servers 7-9 reach a predetermined threshold, the loaded server 7-9 is taken offline and the operation request are automatically directed to other servers 7-9.

This system differs from traditional load balancing and clustering implementations in that it does not use a “round robin” approach to load balancing, but rather it monitors actual work load across the various server types and distributes the load according to function, not simply the number of users. It also directs traffic to “near” servers and protects the DNS from hackers at the same time. It also allows for requests to begin on one server and respond from another.

One or more monitoring computers also monitor specific directories on the servers 5-11, including other monitoring servers and other needed servers for administrative access. If any administrative access has been made to either servers 5-11 or the other needed servers, the monitoring computers cause that accessed server 5-11 to be taken out of service and to notify designated security personnel.

The DNS Server 3, like the Web Servers 5, have telnet, ftp, rlogin, ssh and all other public administrative access methods disabled to deny public administrative access. The DNS Server 3 control Internet traffic to the one or more online Web Servers 5. Each DNS can have as many Web Servers 5 as it takes to direct traffic to handle incoming loads. These Web Servers 5 are selected by the monitoring computers to serve data to the users. Additional software (not shown) either physically on the DNS Server 3 or on the monitoring computer monitors the files related to the domain name server on each name server watching to see that none of the files have been modified, and possessing the ability to take a DNS Server 3 offline, thus routing incoming traffic to the next of the 6 registered DNS Server 3 and replace the modified file(s) with correct unmodified file(s) as modifications have been detected.

For added security and integrity to the system, all employee access is accomplished through an employee server that has software on it (not shown) that allows the employee to install and update software on all of the system servers and to access certain information relating to user accounts. This employee server can only be used by employees that are validated and authenticated in the same manner as users are validated and authenticated above.

An embodiment of the invention also provides a method for securing communications between parties that involve the use of the internet, wireless, local area networks, and wide area networks, and protecting data stored on one or more individual computers, wide area networks, and local area networks by using an internal network interface card (not shown), an external hardware component that can interface with an internal network interface card and router (not shown), or an external router that are modified to add an authentication layer (not shown), that encapsulates the inner data layer creating a new data and/or cyclic redundancy check layer, to any data sent in packets by the Client 13, or other device, including but not limited to wireless telephone and personal data assistance devices, and are modified to add an authentication layer (not shown), that encapsulates the inner data layer creating a new data and/or cyclic redundancy check layer, to any data sent in packets by the Client 13, or other device, including but not limited to wireless telephone and personal data assistance devices, and modified to request authentication from the server system of any data packets being received by the Client 13, or other device, including but not limited to wireless telephone and personal data assistance devices, by using software on the local computer that interacts with the network interface card to remove unwanted user specified elements such as active x, cookies, known viruses, and/or unauthorized access to unused ports, and permit anonymity of the user while browsing public networks, by using software on the local computer that interacts with the network interface card to remove personal and other identifying information from the packet and to optionally compress/decompress data, and by using the internal network card as either an additional encryption/decryption device or as a replacement for the encryption/decryption performed by the EDD in which case the PID would be inserted into a device that performs all of the previous functions of the EDD without the encryption/decryption.

Both methods for securing communications and protecting data include using this technology at server and card level to reject any incoming packets that have no authentication layer and reject any incoming packets whose authentication does not validate, thus making the server secure from unauthorized external access.

An alternative embodiment of the present invention that involves securing communications and protecting data includes using the server system to proxy HTTP packets between the user and third party by having the HTTP packets from the users be sent to the server system, the server system validating the header packet, the server system relaying it to the third party, adding authentication layer information as appropriate, and performing a similar procedure where HTTP packets from the third party are sent to the server system, validated, and relayed to the user, thus validating user access to public information servers, to help protect them from unauthorized access.

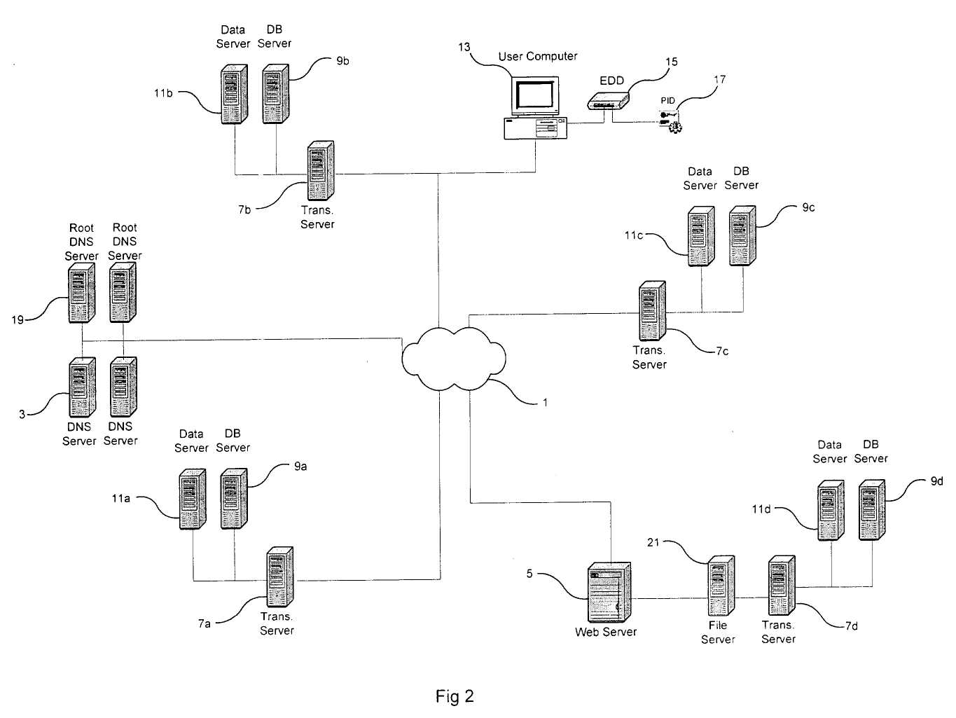

Another embodiment of the invention, shown in FIG. 2, is similar to the system shown in FIG. 1, with the addition of the alternative embodiment of one or more offline or privately connected file servers 21 that fit into the system between the Web Servers 5 and the Transaction Server 7. Each of these file servers 21 is connected to a specific online Web Server 5, one or more specific offline monitor Server 7, one or more offline or privately connected Database Server 9, one or more Data Servers 11, one or more online or privately connected third party transaction servers and one or more DNS Server 3. These file servers 21 possess function specific directories and folders that are monitored by software (not shown) on servers 5-11. The file servers 21 are passive in that no executable software is present on them. Incoming files are written to function-specific directories with only read and write access. The results are returned into function specific directories with only read and write access oring computers , one or more specific offline or privately connected Transaction. All other directories have no user access.

In this embodiment of the present invention, the servers 5-11 each possess application software that can either write, retrieve or delete information on one or more specific directories and folders on the file servers 21. In this embodiment, the monitoring computer can monitor the folders on the file server 21 and remove or delete any files that have been in the folder more than a specified period of time.

The offline file servers can also receive load files from the one or more other servers 5-11. This way, the offline monitoring computers only have to continuously monitor the specific directories of the file servers 21 for the load files of the other servers and then react as needed.

Alternatively, Data Servers 11 can be directly connected to one or more file servers 21 as workstations and perform the same functions as Transaction Servers and Database Servers 7 & 9. On the other hand, if they are configured as file servers with Transaction Servers and Database Servers 7 & 9 connected as workstations to them, a greater level of security is provided.

The advantages of this embodiment of the present invention are that the data is less likely to be intercepted mid-transaction, there is a holding area for data as opposed to the data being lost, and there is greater virus protection. However, the first embodiment without the file servers 21 is generally faster.

What is claimed is:

1. A system comprising:
a first device comprising a processor and a memory that stores a series of at least one value and a plurality of encrypting and decrypting processes; and
a second device comprising a processor and a memory that stores the same series of at least one value that is stored in the first device and a plurality of encrypting and decrypting processes;
wherein the first device further comprises:
means for establishing an encrypted communications session with the second device using at least one of the plurality of encrypting and decrypting processes selected from the plurality of encryption and decryption processes; and
means for selecting the encrypting and decrypting processes as a function of one or more of the at least one of the plurality of values of the stored series.

2. The system of claim 1 wherein the means for establishing an encrypted communications session further changes the selected encrypting and decrypting processes during the secure communications session as a function of the data communicated in the communications session.

3. The system of claim 2 wherein the point at which the encrypting and decrypting processes is changed is determined as a function of one or more of the at least one of the plurality of values of the stored series.

4. The system of claim 1 wherein the first and second devices use the same series of at least one value in the selection of the encryption and decryption process.

5. The system of claim 4 wherein at least a portion of the series of a plurality of values is determined by an algorithm stored in the first and second devices.

6. The system of claim 1, further comprising a third computing device comprising a memory that stores a second series of at least one value that is different from the series of at least one value stored in the first computing device and a plurality of encrypting and decrypting processes;
wherein the memory of the second device further stores the second series of at least one value;
wherein the third device further comprises:
means for establishing an encrypted communications session with the second device using at least one of the plurality of encrypting and decrypting processes selected from the plurality of encryption and decryption processes; and
means for selecting the encrypting and decrypting processes as a function of one or more of the at least one of the plurality of values of the second stored series.

7. The system of claim 6 wherein at least one of the plurality of encrypting and decrypting processes stored in the third device is not contained in the plurality of encrypting and decrypting processes stored in the first device.

8. The system of claim 1 wherein the series of at least one value is used as a key generator for an encryption process other than the encrypted communications session.

9. In a system comprising first and second devices comprising processors which each store the same series of at least one value and each store a plurality of encrypting and decrypting processes, the method comprising the steps:
the first device establishing an encrypted communications session with the second device using at least one of the plurality of encrypting and decrypting processes selected from the plurality of encryption and decryption processes; and
selecting the encrypting and decrypting processes as a function of one or more of the at least one of the plurality of values of the stored series.

10. The method of claim 9 further comprising:
changing the selected encrypting and decrypting processes during the secure communications session as a function of the data communicated in the communications session.

11. The method of claim 10 further comprising:
determining the point at which the encrypting and decrypting processes is changed as a function of one or more of the at least one of the plurality of values of the stored series.

12. The method of claim 9 wherein the first and second devices use the same series of at least one value in selecting the encryption and decryption process.

13. The method of claim 12 wherein at least a portion of the series of a plurality of values is determined by an algorithm stored in the first and second devices.

14. The method of claim 9, wherein the method is performed in a system further comprising a third device comprising a processor storing a second series of at least one value that is different from the series of at least one value stored in the first device; the method further comprises:
storing the second series of at least one value in the second device;
establishing an encrypted communications session between the second and third devices using at least one of the plurality of encrypting and decrypting processes selected from the plurality of encryption and decryption processes; and
selecting the encrypting and decrypting processes for the communication session between the second and third devices as a function of one or more of the at least one of the plurality of values of the second stored series.

15. The method of claim 14 wherein at least one of the plurality of encrypting and decrypting processes stored in the third device is not contained in the plurality of encrypting and decrypting processes stored in the first device.

16. The method of claim 9 wherein the series of at least one value is used as a key generator for an encryption process other than the encrypted communications session.
